(19) United States
(12) Patent Application Publication
(10) Pub. No.: US 2025/0265068 A1
(43) Pub. Date: Aug. 21, 2025

(54) UPDATING DEVICE

(71) Applicant: TOYOTA JIDOSHA KABUSHIKI KAISHA, Toyota-shi (JP)

(72) Inventors: Kento IWAHORI, Nagoya-shi (JP); Shogo YASUYAMA, Okazaki-shi (JP)

(73) Assignee: TOYOTA JIDOSHA KABUSHIKI KAISHA, Toyota-shi (JP)

(21) Appl. No.: 19/050,709

(22) Filed: Feb. 11, 2025

(30) Foreign Application Priority Data
Feb. 19, 2024 (JP) 2024-022675

(51) Int. Cl. G06F 8/65

(52) U.S. Cl. CPC G06F 8/65

(57) ABSTRACT

An updating device for updating software stored in a moving object includes a memory storing program instructions and a processor configured to execute the program instructions to determine whether or not an updating of the software is possible. In a first case that update target information satisfies a predetermined condition; the processor executes the program instructions to determine whether or not the updating of the software is possible by a first method. In a second case that the update target information does not satisfy the predetermined condition, the processor executes the program instructions to determine whether or not the updating of the software is possible by a second method that has a higher security level than the first method.

### CROSS REFERENCE TO RELATED APPLICATIONS

The present application claims priority based on the Japanese application of the application number 2024-022675, filed Feb. 19, 2024, the entire disclosure of which is hereby incorporated by reference.

### BACKGROUND

### Field

This disclosure relates to an updating device.

### Related Art

A technique for operating a vehicle unmanned by remote control in a manufacturing process of a vehicle is known (for example, refer to JP2017-538619A).

Software for controlling a vehicle may need to be updated if a problem occurs in a vehicle manufacturing process. It is necessary to carry out the predetermined certification procedure for the update of the software concerned, and there is a problem that the time required for the update of the software increases for the certification procedure. On the other hand, if the security level of the authentication condition is lowered, it becomes difficult to guarantee the security of the software. Such issues are not limited to a vehicle, but also apply to any moving object.

### SUMMARY

In accordance with one aspect of the present disclosure, there is provided an updating device for updating software stored in a moving object. The control device includes a memory storing program instructions and a processor configured to execute the program instructions to determine whether or not an updating of the software is possible. In a first case that update target information satisfies a predetermined condition, the processor executes the program instructions to determine whether or not the updating of the software is possible by a first method. In a second case that the update target information does not satisfy the predetermined condition, the processor executes the program instructions to determine whether or not the updating of the software is possible by a second method that has a higher security level than the first method.

### BRIEF DESCRIPTION OF THE DRAWINGS

FIG. 1 is a conceptual diagram showing the configuration of a system of the first embodiment,

FIG. 2 is a block diagram showing a configuration of a system of the first embodiment,

FIG. 3 is a flow chart showing the process of the travel control of a vehicle in the first embodiment,

FIG. 4 is a flow chart showing the procedure of the updating process in the first embodiment,

FIG. 5 is a flow chart showing the procedure of the updating process in the second embodiment,

FIG. 6 is a block diagram showing a configuration of a system in the third embodiment, and

FIG. 7 is a flow chart showing the process of the travel control of a vehicle according to the third embodiment.

### DETAILED DESCRIPTION

### A. First Embodiment

### A-1. System Configuration:

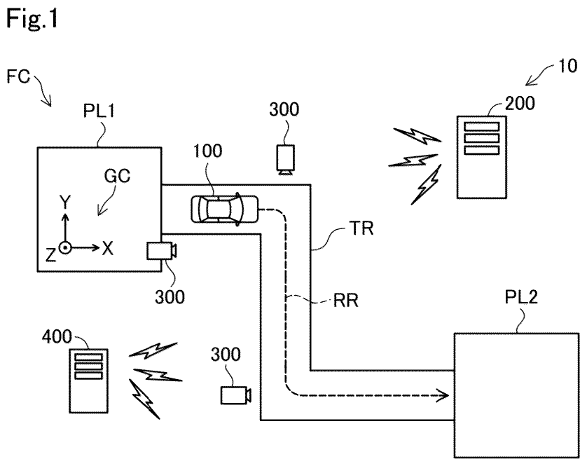

FIG. 1 is a conceptual diagram showing the configuration of system 10 of the first embodiment. System 10 comprises one or more vehicle 100 as a moving object, a server device 200, one or more external sensor 300, and a process control device 400 that controls the fabrication of the vehicle 100 in a plant FC.

In this disclosure, “the moving object” or “moving objects” means a moving object or moving objects, such as a vehicle or an electrically powered vertical takeoff and landing vehicle (so-called flying vehicle). The vehicle may be a vehicle driven by wheels or a vehicle driven by infinite tracks, for example, passenger cars, trucks, buses, motorcycles, automobiles, tanks, construction a vehicle, and the like. The vehicle includes electric vehicle (BEV: Battery Electric Vehicle), gasoline-powered vehicle, hybrid-powered vehicle, and fuel-cell vehicle. When the moving object is other than a vehicle, the expression “a vehicle” and “vehicles” in the present disclosure can be appropriately replaced with “a moving object,” and the expression “driving” can be appropriately replaced with “moving.”

The vehicle 100 is configured to be able to travel by unmanned driving. “Unmanned driving” means driving that does not depend on the traveling operation of the passenger. Traveling operation means an operation relating to “running”, “turning” or “stopping” of the vehicle 100. Unmanned driving may be accomplished by automated or manual remote control using a device located external to the vehicle 100, or by autonomous control of the vehicle 100. An occupant who does not perform the traveling operation may be aboard the vehicle 100 that is traveling by unmanned driving. The passengers who do not perform the traveling operation include, for example, those who are simply seated in the seats of the vehicle 100 and those who are performing operations that differ from the traveling operation such as assembling, inspecting, and operating switches on the vehicle 100. Incidentally, the driving by the traveling operation of the passenger is sometimes referred to as “manned driving”.

In this specification, “remote control” includes “full remote control” in which all of the operations of the vehicle 100 are completely determined from the outside of the vehicle 100, and “partial remote control” in which a part of the operations of the vehicle 100 are determined from the outside of the vehicle 100. Further, “autonomous control” includes “fully autonomous control” in which the vehicle 100 autonomously controls the operation of itself without receiving any information from the device outside the vehicle 100, and “partially autonomous control” in which the vehicle 100 autonomously controls the operation of itself using information received from the device outside the vehicle 100. In the following explanation, the control for the traveling of the vehicle 100 realized by remote control or autonomous control is also referred to as “traveling control”. The travel control corresponds to “movement control” in the present disclosure.

In this embodiment, system 10 is used in the plant FC of manufacturing the vehicle 100. The plant FC frame of reference is the global coordinate system GC. That is, any position in the plant FC is represented by X,Y,Z coordinates in the global coordinate system GC. The plant FC has a 1st location PL1 and the 2nd location PL2. The 1st location PL1 and the 2nd location PL2 are connected by a runway TR on which the vehicle 100 can travel. The plant FC has a number of external sensors 300 installed along the runway TR. The position of the external sensor 300 in the plant FC is pre-adjusted. The 100v . . . the vehicle 100 moves through the runway TR from the 1st location PL1 to the 2nd location PL2 by unmanned operation.

The external sensor 300 is a sensor located outside the vehicle 100 and acquires information about the vehicle 100. The external sensor 300 in this embodiment is a sensor for capturing the vehicle 100 from the outside of the vehicle 100. Specifically, the external sensor 300 is configured by a camera. Camera as the external sensor 300 captures a captured image including the vehicle 100, and outputs a captured image as a detected result. The external sensor 300 includes a communication device (not shown) and is capable of communicating with other devices, such as the server device 200, via wired or wireless communication.

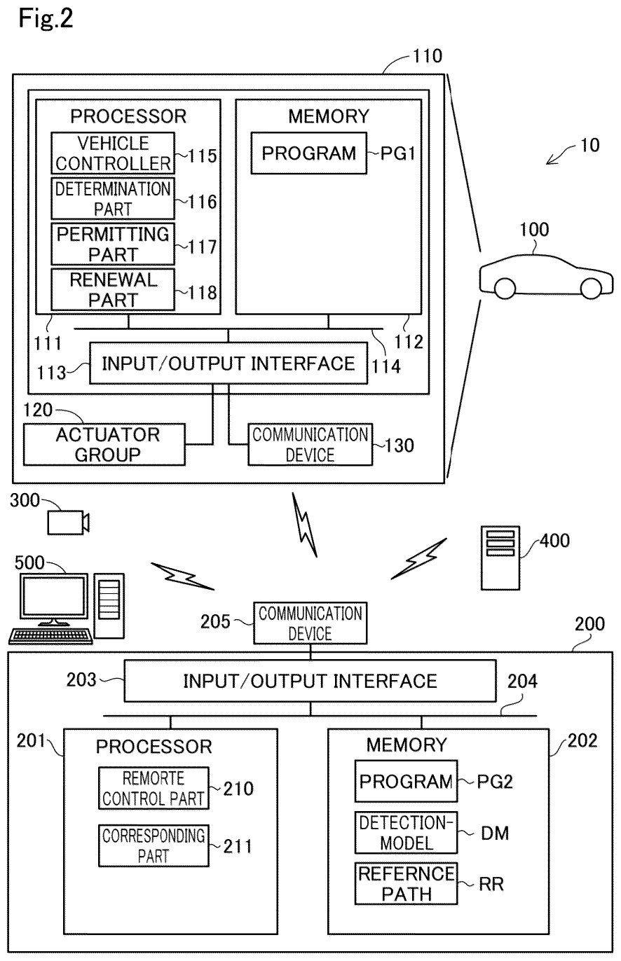

FIG. 2 is a block diagram showing a configuration of the system 10 of the first embodiment. The vehicle 100 includes a vehicle controller 110 for controlling the various parts of the vehicle 100, an actuator group 120 including one or more actuators driven under the control of the vehicle controller 110, and a communication device 130 for wireless communication with an external the device such as a server device 200. The actuator group 120 includes an actuator of the drive the device for accelerating the vehicle 100, an actuator of the steering the device for changing the heading of the vehicle 100, and an actuator of the braking the device for decelerating the vehicle 100. In addition, the vehicle 100 may include various sensors (not shown) such as a vehicle speed sensor and a yaw rate sensor.

The vehicle controller 110 is constituted by a computer including a processor 111, a memory 112, an input/output interface 113, and an internal bus 114. Processor 111, memory 112, and the input/output interface 113 are connected to be able to communicate in both directions via internal bus 114. An actuator group 120 and interface are connected to the input/output interface 113. The processor 111 implements various functions including functions as the vehicle controller 115 by executing a program PG1 stored in memory 112. In this embodiment, the processor 111 functions as a vehicle controller 115, a determination part 116, a permitting part 117, and a renewal part 118.

The vehicle controller 115 drives the vehicle 100 by controlling the actuator group 120. The vehicle controller 115 can drive the vehicle 100 by controlling the actuator group 120 using the travel control signaling received from the server device 200. The travel control signal is a control signal for traveling the vehicle 100. In the present embodiment, the travel control signaling includes the accelerations and steering angles of the vehicle 100 as parameters. In other embodiments, the travel control signaling may include the velocity of the vehicle 100 as a parameter in lieu of or in addition to the accelerations of the vehicle 100.

The determination part 116 determines whether the software stored in the vehicle 100 can be updated. In the present exemplary embodiment, the determination part 116 determines whether or not to update the software by determining whether or not the authentication information output from the terminal device 500 satisfies the authentication condition. The terminal device 500 is a device that is operated by the user to update the software stored in the vehicle 100. In the present exemplary embodiment, the program PG1 stored in the memory 112 of the vehicle 100 corresponds to “software.” Incidentally, the “software” is not limited to the program PG1 and includes software previously stored in the memory 112 and, if required, downloaded from the server device 200 and stored in the memory 112, and includes software for implementing various functions for, for example, part assembly and inspection processes executed in the manufacturing process of the vehicle 100. The terminal device 500 may be provided with a plurality in the plant FC, also may be provided only one. The terminal device 500 is not limited to a stationary device as shown in FIG. 1 but may be a portable terminal such as a smartphone.

When updating the software, the terminal device 500 outputs the authentication data to the vehicle 100 to be updated. “Credentials” means the information used to determine whether or not software can be updated in the update process to be described later. The authentication information includes, for example, the login password of the application for updating the software, the user ID that identifies the user that executes the updating process, the device ID that identifies the terminal device 500 that executes the updating process, and the information that specifies the software to be updated.

The permitting part 117 allows the terminal device 500 to renew software when it determines that the credentials meet the credentials. When software update is permitted, the renewal part 118 updates the software in response to a software update request made by the terminal device 500. That is, the renewal part 118 updates the software if it determines that the credentials meet the credentials. Processor 111 may not include a permitting part 117.

As described above, the vehicle controller 110 of this embodiment functions as the determination part 116, the permitting part 117, and the renewal part 118 to update the software stored in the vehicle 100 when the authentication information satisfies the authentication condition. That is, the vehicle controller 110 of the present embodiment corresponds to the “updating device” in the present disclosure.

The server device 200 consists of a computer with processor 201, the memory 202, the input/output interface 203 and the internal bus 204. Processor 201, memory 202, and the input/output interface 203 are connected to be able to communicate in both directions via internal bus 204. The input/output interface 203 is connected to a communication device 205 for communication with various the device external to the server device 200. The communication device 205 may communicate with the vehicle 100 via wireless communication and may communicate with the external sensor 300 and the process control device 400 via wired or wireless communication.

The processor 201 implements various functions, including functions as a remote control part 210, by executing the program PG2 stored in memory 202. In this embodiment, processor 201 functions as a remote control part 210 and a corresponding part 211.

The remote control part 210 acquires the detection result by the external sensor 300. The remote control part 210 causes the vehicle 100 to travel by remote control by generating a travel control signal instructing control details of the actuator group 120 of the vehicle 100 using the acquired detection result and transmitting the travel control signal to the vehicle 100. The processing procedure of the travel control realized by the remote control of the present embodiment will be described later. The remote control part 210 may generate and output not only a travel control signal but also a control signal for controlling various accessories provided in the vehicle 100 and actuators for operating various equipment such as a wiper, a power window, and a lamp. That is, the remote control part 210 may operate such various equipment and various accessories by remote control.

The corresponding part 211 responds to an inquiry when there is an inquiry from the determination part 116 in the updating process described below. The process of the corresponding part 211 when there is an inquiry from the determination part 116 will be described later.

The process control device 400 is a device for controlling the manufacturing process of the vehicle 100. The process control device 400 is constituted by a computer. The process control device 400 acquires information from various the plant FC facilities, generates information on the manufacturing process of the vehicle 100, and manages it for each the vehicle 100. In the following description, the information about the manufacturing process of the product is referred to as process information. In the present embodiment, the process information includes information indicating when, where, and which worker is to perform what work in which product, information indicating when, where, and where, and which worker has performed what work, and information indicating the progress of the work. The process control device 400 is equipped with a communication device not shown and transmits process data to the server device 200 via wired or wireless communication. The function of the process control device 400 may be implemented on the same device as that of the server device 200. Further, system 10 may not include a process control device 400.

### A-2. Drive Control:

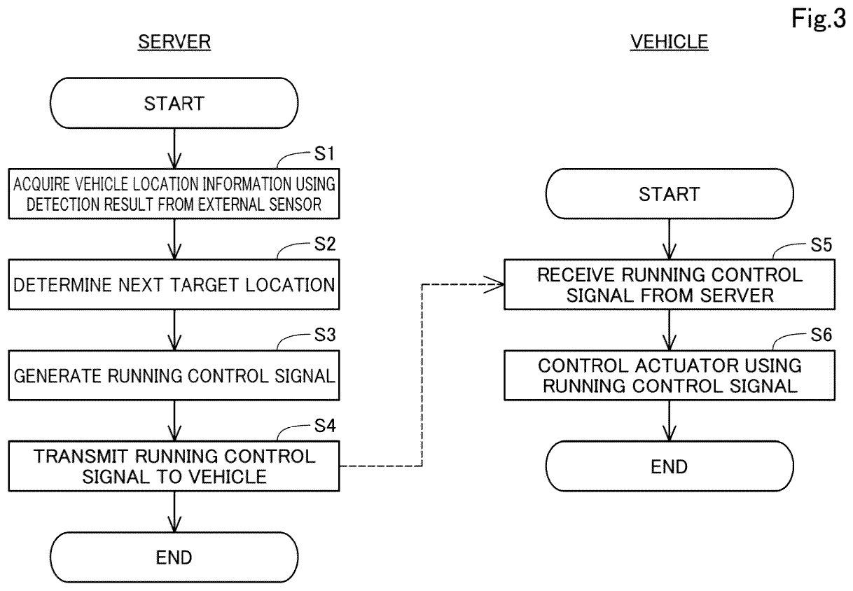

FIG. 3 is a flow chart showing a process sequence of the travel control of the vehicle 100 in the first embodiment. In step S1, the remote control part 210 acquires a vehicle position data of the vehicle 100 using the detected data output from the external sensor 300. The vehicle location information is the underlying location information that generates the travel control signaling. In this embodiment, a vehicle location includes the location and orientation of the vehicle 100 in the plant FC's global coordinate system GC. Specifically, in step S1, the remote control part 210 acquires a vehicle position data using the captured images acquired from the cameras that are the external sensor 300.

Specifically, in the step S1, the remote control part 210 acquires the position of the vehicle 100, for example, by detecting the outer shape of the vehicle 100 from the captured image, calculating the coordinates of the positioning point of the vehicle 100 in the coordinate system of the captured image, that is, the local coordinate system, and converting the calculated coordinates into the coordinates in the global coordinate system GC. The external shape of the vehicle 100 included in the captured image can be detected by, for example, inputting the captured image into an artificial intelligent the detection-model DM. The detection-model DM is prepared, for example, in the system 10 or outside of the system 10 and pre-stored in memory 202 of the server device 200. The detection-model DM includes, for example, trained machine-learning modeling that is trained to realize either semantic segmentation or instance segmentation. As the machine learning model, for example, a convolutional neural network (hereinafter, CNN) learned by supervised learning using a data set for learning can be used. The training dataset includes, for example, a plurality of training images including the vehicle 100 and labels indicating whether each area in the training image is an area indicating the vehicle 100 or an area indicating other than the vehicle 100. When CNN is learned, the parameters of CNN are preferably updated by back propagation to reduce the error between the detection-model DM and the labeling. In addition, the remote control part 210 can acquire the orientation of the vehicle 100 by estimating, for example, based on the orientation of the moving vector of the vehicle 100 calculated from the positional change of the minutiae of the vehicle 100 between the frames of the captured images using the optical flow method.

In step S2, the remote control part 210 determines a target position to which the vehicle 100 is to be directed next. In the present embodiment, the target position is represented by the coordinates of X, Y, Z in the global coordinate system GC. The memory 202 of the server device 200, the reference path RR is previously stored, which is the route the vehicle 100 should travel. The path is represented by a node indicating the starting point, a node indicating the transit point, a node indicating the destination, and a link connecting each node. The remote control part 210 uses a vehicle location data and the reference path RR to determine the target location to be directed to by the vehicle 100 next. The remote control part 210 determines the target position on the reference path RR prior to the current location of the vehicle 100.

In step S3, the remote control part 210 generates a travel control signaling to cause the vehicle 100 to travel toward the determined target position. The remote control part 210 calculates the traveling speed of the vehicle 100 from the transition of the position of the vehicle 100 and compares the calculated traveling speed with the target speed. Overall, the remote control part 210 determines the acceleration so that the vehicle 100 accelerates when the traveling speed is lower than target speed and determines the acceleration so that the vehicle 100 decelerates when the traveling speed is higher than target speed. In addition, the remote control part 210 determines the steering angle and acceleration so that the vehicle 100 does not deviate from the reference path RR when the vehicle 100 is positioned on the reference path RR, and determines the steering angle and acceleration so that the vehicle 100 may return to the reference path RR when the vehicle 100 is not positioned on the reference path RR, in other words, when the vehicle 100 is deviated from the reference path RR.

In step S4, the remote control part 210 transmits the generated travel control signaling to the vehicle 100. At a predetermined cycle, the remote control part 210 repeats acquiring the position of the vehicle 100, determining the target position, generating the travel control signal, and transmitting the travel control signal.

In step S5, the vehicle controller 115 receives a transit control signaling from the server device 200. In step S6, the vehicle controller 115 uses the received travel control signal to control the actuator group 120 so as to drive the vehicle 100 at the accelerations and steering angles indicated by the travel control signal. The vehicle controller 115 repeats receiving the travel control signal and controlling the actuator group 120 at predetermined intervals. According to the system 10 of the present exemplary embodiment, the vehicle 100 can be driven by remote control, and the vehicle 100 can be moved without using a transportation facility such as a crane or a conveyor.

### A-3. Updating Process:

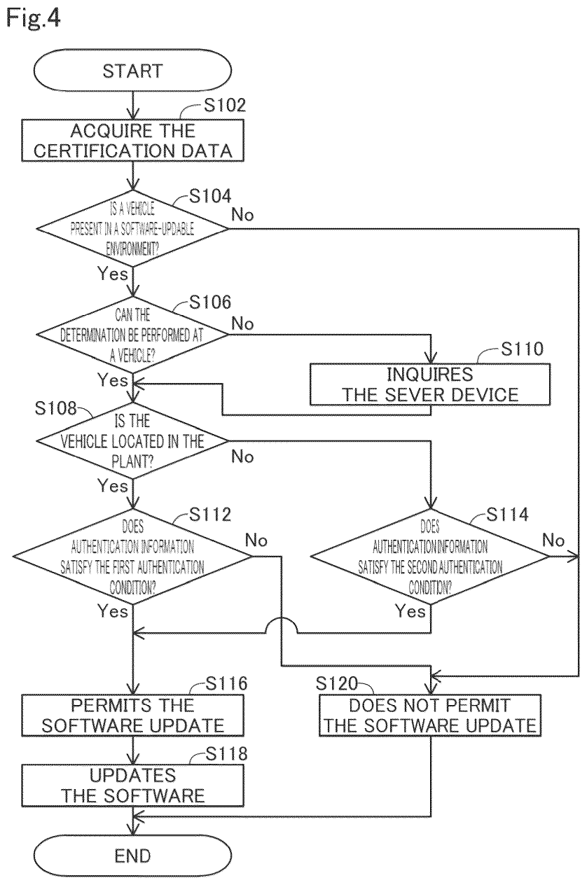

FIG. 4 is a flow chart showing the sequence of the updating process in the first embodiment. The “updating process” is a process of updating the software stored in the vehicle 100 according to a request from the terminal device 500. The terminal device 500 outputs the above-mentioned credentials when a predetermined start operation is entered by the user, and the update processing starts when the credentials are output from the terminal device 500.

In step S102, the determination part 116 acquires the certification data outputted from the terminal device 500.

In step S104, the determination part 116 determines whether or not the vehicle 100 is present in a software-updatable environment. The term “environment in which software can be updated” means an environment that is preset as an environment that does not interfere with control of the vehicle 100 even when software updating is executed. The determination part 116 determines that the software is present in an environment in which the vehicle 100 can update the software when, for example, “the vehicle 100 is stopped and the software to be updated is not in use” is set, and the determination part 116 matches when the present environment of the vehicle 100 is applied. If it is determined that there is no software in the updatable environment (S104: No of steps), the permitting part 117 disables the software-related update, and the update process ends.

If it is determined to be present in the updating environment (step S104: Yes), at step S106, the determination part 116 determines whether or not the determination of the step S108 to be described later can be performed at the vehicle 100. As will be described later, in the present embodiment, the determination is performed using the position information of the vehicle 100 in step S108. “The vehicle 100 location information” is information regarding the vehicle 100 to be updated and corresponds to “the update target information” in this disclosure. In step S106, when the vehicle 100 grasps the position of itself, the determination part 116 determines that the determination of the step S108 can be executed in the vehicle 100. “When the vehicle 100 grasps the position information of itself” means, for example, when the vehicle 100 receives and stores the position information of the vehicle 100 together with the travel control signal or when the vehicle 100 includes a position sensor such as a GPS sensor and the position information of the vehicle 100 is detected by the position sensor.

If it is determined to be able to be determined by the vehicle 100 (step S106: Yes), it is determined whether or not the vehicle 100 is located in the plant FC by the determination part 116 at the step S108. “In the plant FC” corresponds to “a predetermined area” in the present disclosure. Further, “the vehicle 100 is located in the plant FC” corresponds to “a predetermined conditional” in the present disclosure.

If it is determined by the vehicle 100 that the determination cannot be made (Step S106: No), the determination part 116 inquiries about the server device 200 in Step S110. Upon receipt of the query, at the server device 200, the corresponding part 211 responds to the determination part 116 with a vehicle location described above. In addition, instead of a vehicle position information, the corresponding part 211 may answer to the determination part 116 when it determines whether or not the vehicle 100 is located in plant FC by using a vehicle position information. Thereafter, the determination part 116 performs S108 of steps described above.

If it is determined that the vehicle 100 is located within the plant FC (step S108: Yes), in Step S112, the determination part 116 determines whether or not the authentication information satisfies the first authentication condition. Here, “determining whether or not the authentication information satisfies the first authentication condition” corresponds to determination by “the first method” in the present disclosure. In the present exemplary embodiment, the determination part 116 determines whether or not the login password is correct as the first authentication criterion. Instead of determining whether or not the log-in password is correct, the determination part 116 may determine whether or not the terminal device 500 the user is the person having the software update permission or whether or not the terminal device 500 is approved as a device capable of performing the software update. “The 100v . . . the vehicle 100 is determined to be located in the plant FC” corresponds to “the first case” in the present disclosure.

When it is determined that the first authentication condition is satisfied (step S112: Yes), at step S116, the permitting part 117 permits the software update to the terminal device 500, and at step S118, the renewal part 118 updates the software corresponding to the update contents of the software by the terminal device 500. After that, the update processing ends.

If it is determined that the first authentication condition is not satisfied (step S112: No), in step S120, the permitting part 117 does not permit updating of the software. After that, the update processing ends.

If it is determined in the above-described step S108 that the vehicle 100 is not located in the plant FC (step S108: No), in the step S114, the determination part 116 determines whether or not the authentication information satisfies the second authentication condition. Here, “determining whether or not the authentication information satisfies the second authentication condition” corresponds to determination by “the second method” in the present disclosure. In the present embodiment, the determination part 116 determines, as the second authentication criterion, whether or not the login password is correct, whether or not the user of the terminal device 500 is a person who has the software update authority, and whether or not the terminal device 500 is approved as a device that updates the software. In other words, the second authentication condition has many conditions that should be satisfied compared with the first authentication condition. Therefore, the second authentication condition may be higher in security level than first authentication condition, while the second method using the second authentication condition has a higher security level than first method using the first authentication condition. “The vehicle 100 is determined not to be located in the plant FC” corresponds to “the second case” in the present disclosure.

If it is determined that the second authentication criterion is satisfied (step S114: Yes), the above-described step S116 and step S118 are performed. After that, the update processing ends.

If it is determined that the second authentication criterion is not satisfied (step S112: No), the above-described step S120 is executed. After that, the update processing ends.

As described above, in the present embodiment, when it is determined that the vehicle 100 is located in the plant FC, the authentication is performed by the first authentication condition having a lower security level than second authentication condition when it is determined that the vehicle 100 is not located in the plant FC. If the vehicle 100 is located in plant FC, then the software-update operator is likely to be limited to the plant FC operator because of the lower security risk compared to when the vehicle 100 is located outside the plant FC. That is, generally, the determination part 116 appropriately uses the first method using the first authentication condition and the second method using the second authentication condition according to a predetermined condition related to a security risk for updating software. In addition, if the vehicle 100 is located in the plant FC and he tries to update the software, it is considered that he is trying to eliminate some kind of problem that occurred in the manufacturing process of the vehicle 100, because prompt action is required.

According to the system 10 of the first embodiment described above, when it is determined that the vehicle 100 is located in the plant FC, as the authentication condition, it is determined whether or not the first authentication condition is satisfied, and when it is determined that the vehicle 100 is not located in the plant FC, as the authentication condition, it is determined whether or not the second authentication condition having a higher security level than first authentication condition is satisfied. Therefore, when it is determined that the vehicle 100 is located in the plant FC, the authentication can be easily performed by the first authentication condition having a lower security level compared to the second authentication condition, and thus an increase in the duration for updating the software can be suppressed. Further, when it is determined that the vehicle 100 is not located in the plant FC, the authentication can be performed by the second authentication condition having a higher security level compared to the first authentication condition, and the deterioration of the security level can be suppressed compared to the form in which the authentication is performed constantly according to the first authentication condition.

In addition, the first certification condition and the second certification condition can be appropriately used depending on whether or not the vehicle 100 is located in the plant FC.

### B. Second Embodiment

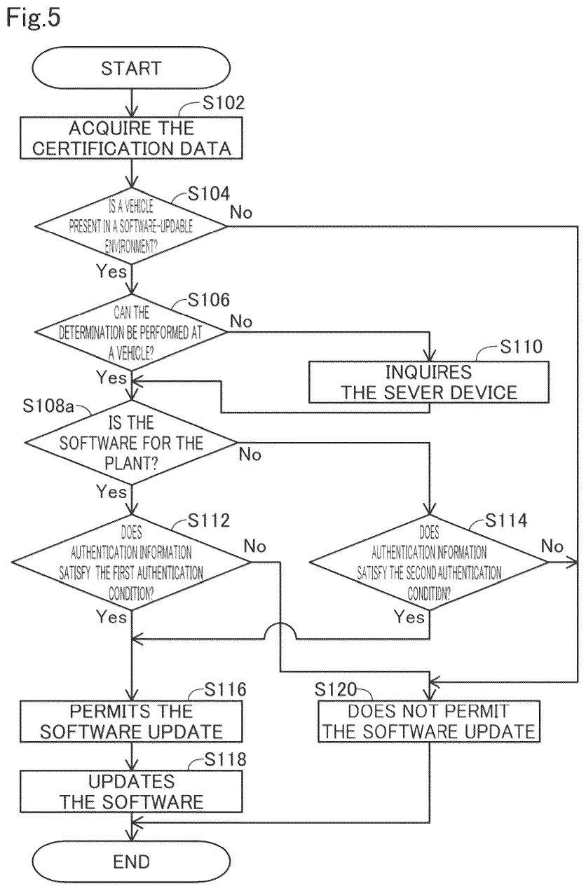

FIG. 5 is a flow chart showing the sequence of the updating process in the second embodiment. As shown in FIG. 5, the system 10 of the second embodiment is different from the system 10 of the first embodiment in that, in the updating process, step S108 is replaced with step S108a. Since another procedure in the system 10 the device configuration and updating process of the second embodiment is the same as the system 10 of the first embodiment, the same configuration and the same procedure are denoted by the same reference numerals, and a detailed description thereof will be omitted.

In the step S106 shown in FIG. 5, the determination part 116 determines whether or not the determination of the step S108a to be described later can be performed on the vehicle 100. As will be described later, in the present embodiment, in step S108a determination according to the application of the software to be updated is performed. “Applications of the software to be updated” are related to the software to be updated and correspond to “the update target information” in this disclosure. In the step S106 of the present embodiment, when the software for controlling the vehicle 100 is stored in the memory 112 of the vehicle 100 so as to be able to determine the purpose of use, the determination part 116 determines that the determination of the step S108a can be executed in the vehicle 100. For example, when the software for controlling the vehicle 100 is recognizably stored, for example, when the database for managing the application of each software is stored in the memory 112 in advance, or when the extension of each software is predetermined according to the application of each software.

When it is determined to be able to be determined in the vehicle 100 (step S106: Yes), the determination part 116 determines whether or not the use of the software to be updated is for the plant in step S108a. In this case, “the software to be updated is for the plant” means that the software is used when the vehicle 100 exists in the plant FC and is not used when the vehicle 100 exists outside the plant FC. More specifically, “software used when the vehicle 100 is present in the plant FC and not used when the vehicle 100 is present outside the plant FC” corresponds to software used to realize various functions for the component assembly process and the inspection process executed in the manufacturing process of the vehicle 100, and does not include software used to realize functions that can be used by the user of the vehicle 100 after shipping of the vehicle 100, for example, a software used to realize an object detecting function using an in-a vehicle sensor.

For example, in the above-described database, when the application of the software to be updated is said to be for the plant, or when the extension of the software to be updated is the same as the extension predetermined as the extension indicating that the extension is for the plant, the determination part 116 determines that the application of the software is for the plant. “The purpose of the software to be updated is for the plant” corresponds to “predetermined conditions” in the present disclosure.

If it is determined by the vehicle 100 that the determination cannot be made (step S106: No), the determination part 116 inquiries about the server device 200 in step S110. Upon receiving an inquiry, at the server device 200, the corresponding part 211 answers to the determination part 116 the use of the software to be updated. For example, the corresponding part 211 identifies the application of the software to be updated by referring to a pre-stored database that manages the application of the software and responds to the determination part 116 for the specified application. Instead of using the software to be updated, the corresponding part 211 may answer to the determination part 116 when it determines whether or not the intended use is for the plant. Thereafter, the determination part 116 performs step S108a described above.

If it is determined that the application of the software to be updated is for the plant (step S108a: Yes), the determination part 116 executes the above-described step S112. “When it is determined that the use of the software to be updated is for the plant” corresponds to “the first case” in the present disclosure. On the other hand, when it is determined that the use of the software to be updated is not for the plant (step S108a: No), the determination part 116 executes the above-described step S114. “When it is determined that the use of the software to be updated is not for the plant” corresponds to “the second case” in the present disclosure.

As described above, in the present embodiment, when it is determined that the use of the software to be updated is for the plant, the authentication is performed by the first authentication condition having a lower security level than second authentication condition when it is determined that the use of the software to be updated is not for the plant. When the application of the software to be updated is for the plant, the software to be updated is not used for the vehicle 100 the user, so it can be said that the effect of software updating on the user of the vehicle 100 is minimal. In addition, when updating the plant software, it is probable that the vehicle 100 is trying to eliminate some kind of problem that occurred in the manufacturing process, and prompt action is required.

According to the system 10 of the second embodiment described above, when it is determined that the use of the software to be updated is for the plant, it is determined as the authentication condition whether the first authentication condition is satisfied, and when it is determined that the use of the software to be updated is not for the plant, it is determined as the authentication condition whether the second authentication condition having a higher security level than first authentication condition is satisfied. Therefore, the first certification condition and the second certification condition can be properly used depending on whether the software to be updated is for the plant or not.

### C. Third Embodiment

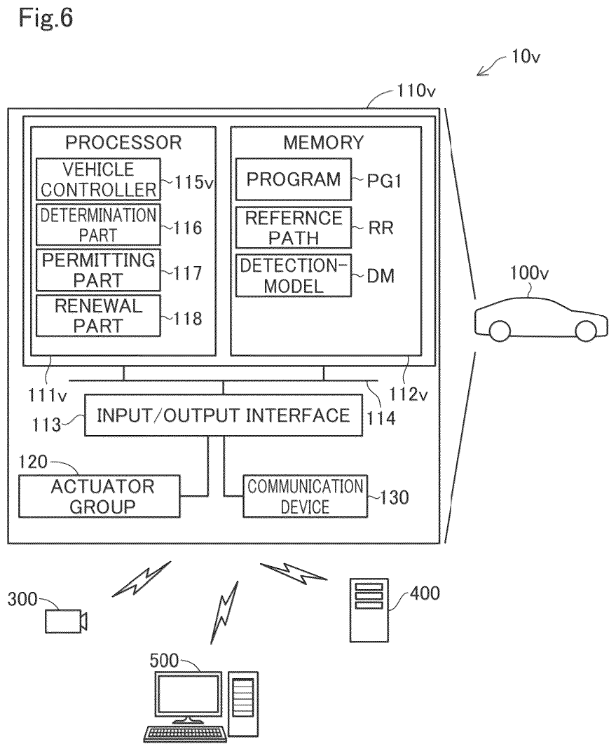

FIG. 6 is a block diagram showing a configuration of a system 10v in the third embodiment. In the present embodiment, the system 10v differs from the first embodiment in that it does not include the server device 200. In addition, the vehicle 100v according to this embodiment can be driven by the autonomous control of the vehicle 100v. For other configurations, unless otherwise described, it is the same as the first embodiment.

In the present exemplary embodiment, the processor 111v of the vehicle controller 110v functions as a vehicle controller 115v, a determination part 116, a permitting part 117, and a renewal part 118 by executing a program PG1 stored in a memory 112v. The vehicle controller 115v generates a travel control signal using a vehicle position information. The generated travel control signal is output to operate the actuator group 120, so that the vehicle 100v can be driven by autonomous control. In the present embodiment, in addition to the program PG1, the detection-model DM and the reference path RR are stored in the memory 112v in advance.

Like the vehicle controller 110 of the first embodiment, the vehicle controller 110v of the present embodiment functions as the determination part 116, the permitting part 117, and the renewal part 118 to update the software stored in the vehicle 100 when the authentication information satisfies the authentication condition. That is, the vehicle controller 110v of the present embodiment corresponds to “the updating device” in the present disclosure.

In the present exemplary embodiment, since the system 10v does not have the server device 200, when it is determined that the determination is not possible at the vehicle 100 in the updating process (step S106: No), the determination part 116 may perform the above-described step S110 and determine whether or not the authentication information satisfies the second authentication condition. According to this aspect, when the determination is possible in the vehicle 100 (step S106: Yes) and the vehicle 100 is located in the plant FC (S108: Yes of steps), the software can be updated as long as the first authentication condition with a lower security level than second authentication condition is satisfied, and thus the software can be updated in the same manner as the above-described embodiment.

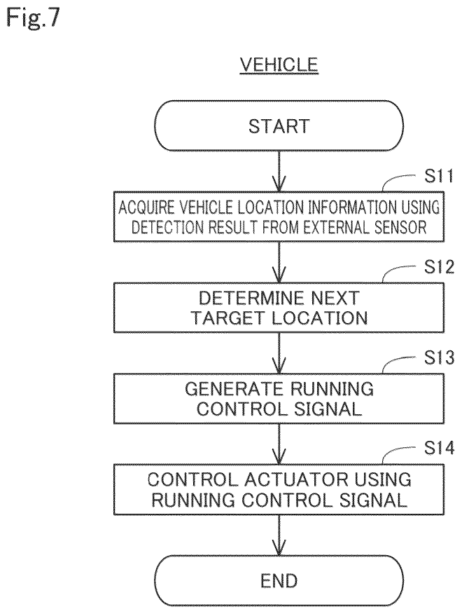

FIG. 7 is a flow chart showing the process of the travel control of the vehicle 100v in the third embodiment. In Step S11, the processor 111v acquires a vehicle position data using the data output from the external sensor 300. In step S11 in the present embodiment, the processor 111v acquires a vehicle position information using the captured image and the a vehicle speed as in step S1 of FIG. 3. In step S12, the processor 111v determines the target position to which the vehicle 100v is to go next. In step S13, the processor 111v generates a travel control signaling to drive the vehicle 100v toward the determined target position. In step S14, the processor 111v uses the generated drive control signal to control the actuator group 120 to drive the vehicle 100v according to the parameter represented in the drive control signal. The processor 111v repeats acquiring a vehicle position data, determining the target position, generating the travel control signal and controlling the actuator group 120 in a predetermined cycle. According to the system 10v of the present exemplary embodiment, the vehicle 100v can be driven by the autonomous control of the vehicle 100v without having to remotely control the server device 200. In addition, the system 10v according to the present exemplary embodiment, as in the above-described exemplary embodiment, the first authentication condition and the second authentication condition can be appropriately used, and a decrease in the security level can be suppressed while suppressing an increase in times for updating software.

### D. Other Embodiments

(D1) In the above embodiment, the determination part 116, the permitting part 117, and the renewal part 118 are provided with the vehicle controller 110, but the present disclosure is not limited thereto. The determination part 116, the permitting part 117 and the renewal part 118 may be provided by the server device 200. In such a configuration, the server device 200 corresponds to “the updating device” in the present disclosure. Incidentally, when the server device 200 functions as an updating device, the step S106 and the step S110 in the updating process are not executed, and when it is determined as “Yes” in the step S104, the step S108 may be executed.

(D2) In the above embodiment, the determination part 116 determines whether or not the vehicle 100 is located in the plant FC by using the position info of the vehicle 100, but the present disclosure is not limited thereto. Determination part 116 may use the process info to determine whether or not the vehicle 100 is located in the plant FC. For example, the determination part 116 may determine whether or not the vehicle 100 is located in the plant FC according to whether or not the vehicle 100 is located in the previous process than predetermined process. More specifically, when it is determined that the vehicle 100 is positioned in the previous process than final testing process by using the process information of the vehicle 100, the determination part 116 may determine that the vehicle 100 is positioned in the plant FC. On the other hand, if the process data of the vehicle 100 is used to identify that the vehicle 100 is located in a later process than final testing process, the determination part 116 may determine that the vehicle 100 is not located in the plant FC. In such a mode, when the process information is not stored in the memory 112 of the vehicle 100, in the above-described step S110, the determination part 116 may inquire about the process information to the process control device 400 in place of the server device 200 and obtain the process information from the process control device 400. According to such embodiments, it achieves the same effect as the above embodiment.

(D3) In the above-described embodiment, the vehicle 100 may include a first control device that stores software for the plant and a second control device that stores software for applications other than plant. In this embodiment, when the software to be updated is stored in the first control device, the determination part 116 may perform the authentication under the first authentication condition assuming that the software is for the plant. On the other hand, when the software to be updated is stored in the second control device, the determination part 116 may perform the authentication under the second authentication condition assuming that the software is not for the plant. According to this aspect, since the software having different applications is stored in different control the device, it is possible to easily manage the software, it is possible to easily determine S108a of steps in the updating process of the second embodiment. In such a form, the “first control the device for executing the software for the plant” corresponds to the “predetermined the device” in the present disclosure.

In addition, the vehicle 100 may include, in the vehicle controller 110, a first the plant that stores software for the plant and a second the memory that stores software for applications other than a vehicle. In this embodiment, when the software to be updated is stored in the first memory, the determination part 116 may perform the authentication under the first authentication condition assuming that the software is for the plant. On the other hand, when the software to be updated is stored in the second memory, the determination part 116 may authenticate according to the second certification requirement, assuming that the software is not for the plant. Even in such a configuration, since software of different applications is stored in different the memory each other, software can be easily managed, and determination of step S108a in the updating process of the second embodiment can be facilitated. In this embodiment, the first memory for storing the software for the plant corresponds to a predetermined the device in the present disclosure.

(D4) In the above embodiments, the external sensor 300 is a camera. In contrast, the external sensor 300 may not be a camera. For example, it may be a ranging the device. The ranging device may be, for example, LiDAR (Light Detection And Ranging). In this instance, the detected data output by the external sensor 300 may be three-dimensional point cloud data representing the vehicle 100. In this instance, the server device 200 or the vehicle 100 may acquire a vehicle position information by template matching using the three-dimensional point cloud data as the detection result and the reference point cloud data prepared in advance.

(D5) In the above-described first exemplary embodiment, the process from the acquiring of a vehicle position information to the generation of the travel control signal is executed by the server device 200. In contrast, at least a part of the process from the acquiring of a vehicle position information to the generation of the travel control signal may be executed by the vehicle 100. For example, it may be in the form of (1) to (3) below.

(1) The server device 200 may acquire a vehicle location information, determine a target position to be directed next by the vehicle 100, and generate a path from the current location of the vehicle 100 to the target position represented by the acquired a vehicle location information. The server device 200 may generate a route to the target position between the present location and the destination or may generate a route to the destination. The server device 200 may transmit the generated path to the vehicle 100. The vehicle 100 may create a travel control signal such that the vehicle 100 travels on a route received from the server device 200 and control the actuator group 120 using the generated travel control signal.

(2) The server device 200 may acquire a vehicle location information and transmit the acquired a vehicle location information to the vehicle 100. The vehicle 100 may determine a target position to be directed next by the vehicle 100, generate a route from the present location to the target position of the vehicle 100 represented by the received a vehicle position information, create a travel control signal such that the vehicle 100 travels on the generated route, and control the actuator group 120 using the generated travel control signal.

(3) In the above-described forms (1) and (2), the internal sensor is mounted on the vehicle 100, and at least one of generation of the route and generation of the travel control signal may be used as the detection result outputted from the internal sensor. The inside sensor is the sensor mounted on the vehicle 100. The inner sensors may include, for example, sensors that detect the motion state of the vehicle 100, sensors that detect the operation state of each part of the vehicle 100, and sensors that detect the ambient environment around the vehicle 100. Specifically, the inner sensors may include, for example, cameras, LiDAR, millimeter-wave radars, ultrasonic sensors, GPS sensors, accelerometers, gyrosensors, etc. For example, in the form of (1) above, the server device 200 may acquire the detection result of the internal sensor and reflect the detection result of the internal sensor in the path when generating the path. In the form of (1), the vehicle 100 may acquire the detection result of the internal sensor and reflect the detection result of the internal sensor in the travel control signal when creating the travel control signal. In the form of (2) described above, the vehicle 100 may acquire the detection result of the internal sensor and reflect the detection result of the internal sensor in the path when generating the path. In the form of (2) described above, the vehicle 100 may acquire the detection result of the internal sensor and reflect the detection result of the internal sensor in the travel control signal when creating the travel control signal.

(D6) In the above-described third embodiment, the internal sensor may be mounted on the vehicle 100v, and at least one of generation of the route and generation of the travel control signal may be used as the detection result outputted from the internal sensor. For example, the vehicle 100v may obtain the detection result of the internal sensor and reflect the detection result of the internal sensor in the path when generating the path. The vehicle 100v may acquire the detection result of the internal sensor and reflect the detection result of the internal sensor in the travel control signal when creating the travel control signal.

(D7) In the above-described embodiment in which the vehicle 100 can be driven by the autonomous control, the vehicle 100 acquires a vehicle position information using the detection result of the external sensor 300. In contrast, an internal sensor is mounted in the vehicle 100, and the vehicle 100 acquires a vehicle position information using the detection result of the internal sensor, the vehicle 100 determines the target position to be directed to the next, generates a route from the current location of the vehicle 100 represented by the acquired a vehicle position information to the target position, creates a travel control signal for traveling the generated route, and controls the actuator of the vehicle 100 using the generated travel control signal. In this instance, the vehicle 100 may run without using any of the findings of the external sensor 300. The vehicle 100 may acquire the target arrival time and the congestion information from the outside of the vehicle 100 and reflect the target arrival time and the congestion information in at least one of the routes and the travel control signal. Further, the functional configuration of system 10 may be all provided in the vehicle 100. In other words, the process realized by system 10 in the present disclosure may be realized by the vehicle 100 alone.

(D8) In the above-described first exemplary embodiment, the server device 200 automatically generates a travel control signal to be transmitted to the vehicle 100. In contrast, the server device 200 may generate a travel control signaling for transmission to the vehicle 100 in accordance with the manipulation of an external operator located outside the vehicle 100. For example, an external operator may operate a control the device including a display for displaying captured images outputted from the external sensor 300, a steering for remotely operating the vehicle 100, an accelerator pedal, a brake pedal, and a communication device for communicating with the server device 200 through wired or wireless communication, and the server device 200 may create a travel control signal corresponding to an operation applied to the control the device.

(D9) In the above embodiments, the vehicle 100 may have a configuration that can be moved by unattended operation, and may, for example, be in the form of a platform that includes the configuration described below. Specifically, the vehicle 100 may be provided with at least a control the device for controlling the traveling of the vehicle 100 and actuators such as a drive the device, a steering the device, and a braking the device in order to perform three functions of “traveling,” “turning,” and “stopping” by unattended operation. If the vehicle 100 acquires data from an external source for unmanned operation, the vehicle 100 may further include communication device. That is, the vehicle 100 that can be moved by unmanned operation may not have at least a part of the interior components such as the driver's seat and the dashboard mounted, may not have at least a part of the exterior components such as the bumper and the fender mounted, and may not have the body shell mounted. In this instance, the remaining components, such as the body shell, may be attached to the vehicle 100 until the vehicle 100 is shipped from the plant FC, or the remaining components, such as the body shell, may be attached to the vehicle 100 after the vehicle 100 is shipped from the plant FC without the remaining components, such as the body shell, being attached to the vehicle 100. The components may be mounted from any direction, such as the upper side, lower side, front side, rear side, right side or left side of the vehicle 100, and may be mounted from the same direction or from different directions. Also, with respect to the form of a platform, location can be determined in the same manner as in the vehicle 100 in the first embodiment.

(D10) the vehicle 100 may be manufactured by combining a plurality of modules. Module means a unit composed of one or more components summarized according to the configuration and functions of the vehicle 100. For example, the platform of the vehicle 100 may be manufactured by combining a front module which constitutes a front portion of the platform, a central module which constitutes a central portion of the platform, and a rear module which constitutes a rear portion of the platform. The number of modules constituting the platform is not limited to three, it may be two or less or four or more. Also, in addition to or in place of the platform, parts of the vehicle 100 that differ from the platform may be modularized. The various modules may also include any exterior components, such as bumpers and grills, and any interior components, such as seats and consoles. Further, not limited to the vehicle 100, the moving object of any aspect may be manufactured by combining a plurality of modules. Such modules, for example, may be manufactured by joining a plurality of parts by welding or fasteners or the like, it may be manufactured by integrally molding at least a portion of the module as one part by casting. Molding method for integrally molding at least a portion of the module as one part, also referred to as giga-cast or mega-cast. By using Giga cast, conventionally, each portion of the moving object which has been formed by joining a plurality of components, can be formed as a part. For example, the front module and the central module and the rear module described above may be manufactured using giga casts.

(D11) Using the travel of the vehicle 100 by unmanned operation to convey the vehicle 100 is also referred to as “self-propelled conveyance.” The configuration for realizing self-propelled transportation is also called “a vehicle Remotely Controlled Autonomous Transfer the system”. The production method that uses self-propelled conveyance to produce the vehicle 100 is also called “self-propelled production.” In self-propelled manufacturing, for example, at least a portion of the conveyance of the vehicle 100 in the plant FC of manufacturing the vehicle 100 is realized by self-propelled conveyance.

(D12) In each of the above embodiments, some or all of the functions and processing implemented in software may be implemented in hardware. In addition, some or all of the functions and processes implemented in hardware may be implemented in software. As hardware for realizing various functions in the above embodiments, for example, it may be used various circuits such as integrated circuits and discrete circuits.

The present disclosure is not limited to the above-described embodiments and can be realized with various configurations without departing from the spirit thereof. For example, the technical features in each embodiment may be replaced or combined as appropriate in order to solve some or all of the above-described problems or to achieve some or all of the above-described effects. In addition, if the technical features are not described as indispensable in this specification, they can be deleted as appropriate. For example, the present disclosure may be realized by aspects described below.

(1) In accordance with one aspect of the present disclosure, there is provided an updating device for updating software stored in a moving object. The control device includes a memory storing program instructions and a processor configured to execute the program instructions to determine whether or not an updating of the software is possible. In a first case that update target information satisfies a predetermined condition; the processor executes the program instructions to determine whether or not the updating of the software is possible by a first method. In a second case that the update target information does not satisfy the predetermined condition, the processor executes the program instructions to determine whether or not the updating of the software is possible by a second method that has a higher security level than the first method.

According to the control the device of this aspect, in a first case where the update target information satisfies a predetermined condition, the update availability is determined by the first method, and in a second case where the update target information does not satisfy the predetermined condition, the update availability is determined by the second method with a higher security level than first method. Therefore, in the first case, it is possible to easily determine the update availability by the first method having a lower security level compared to the second method, it is possible to suppress an increase in time for updating the software. Further, in the second case, the update availability can be determined by the second method having a higher security level compared to the first method, and the deterioration of the security level can be suppressed compared to the form in which the update availability is always determined by the first method.

(2) In the above aspect, the predetermined condition may include that the moving object is located in a predetermined area.

According to the control the device of this aspect, since the predetermined condition includes that the moving object is located within the predetermined region, the first method and the second method can be appropriately used depending on whether the moving object is located within the predetermined region or not.

(3) In the above aspect, the predetermined condition may include that the software is software used when the moving object is present in a predetermined area.

According to the control the device of this aspect, since the software includes the software used when the moving object is present in a predetermined area first method and the second method can be appropriately used depending on whether the software is the software used when the moving object is present in a predetermined area.

(4) In the above aspect, the predetermined condition may include that the software is stored in a predetermined device.

According to the control the device of this aspect, since the predetermined condition includes that the software is stored in the predetermined the device, the first method and the second method can be easily used separately depending on whether the software is stored in the predetermined the device.

What is claimed is:

1. An updating device for updating software stored in a moving object, comprising:
a memory storing program instructions; and
a processor configured to execute the program instructions to determine whether or not an updating of the software is possible, wherein
in a first case that update target information satisfies a predetermined condition, the processor executes the program instructions to determine whether or not the updating of the software is possible by a first method,
in a second case that the update target information does not satisfy the predetermined condition, the processor executes the program instructions to determine whether or not the updating of the software is possible by a second method that has a higher security level than the first method.

2. The updating device according to claim 1, wherein
the predetermined condition includes that the moving object is located within a predetermined area.

3. The updating device according to claim 1, wherein
the predetermined condition includes that the software is software to be used when the moving object is within a predetermined area.

4. The updating device according to claim 1, wherein
the predetermined condition includes that the software is stored in a predetermined device.
